(19) United States
(12) Patent Application Publication
(10) Pub. No.: US 2026/0274326 A1
(43) Pub. Date: Sep. 17, 2026

(54) STEERING APPARATUS

(71) Applicant: YAMADA MANUFACTURING CO., LTD., Gunma (JP)

(72) Inventors: Koji Hirooka, Kiryu-shi (JP); Yasushi Yokokura, Kiryu-shi (JP)

(21) Appl. No.: 19/555,129

(22) Filed: Mar. 3, 2026

(30) Foreign Application Priority Data
Mar. 17, 2025 (JP) 2025-042744

(51) Int. Cl. B62D 1/19

(52) U.S. Cl. CPC B62D 1/192

(57) ABSTRACT

A steering apparatus includes an outer column that holds an inner pipe, which accommodates a steering shaft, so as to be movable and fixable in a vehicle front-rear direction. The outer column includes a holding cylinder that holds the inner pipe, an upper extension portion extending from an upper portion of the holding cylinder toward a front of a vehicle body, a lower extension portion extending from a lower portion of the holding cylinder toward the front of the vehicle body, and a support portion formed integrally with a front end of the upper extension portion and a front end of the lower extension portion and supporting the steering shaft. A space between the upper extension portion and the lower extension portion penetrates entirely from the holding cylinder to the support portion in a vehicle width direction.

### BACKGROUND OF THE INVENTION

### 1. Field of the Invention

The present invention relates to an improvement technology for a steering apparatus including a telescopic adjustment mechanism.

### 2. Description of the Related Art

Vehicles are driven by drivers of various body sizes. In recent years, a steering apparatus including a telescopic adjustment mechanism for adjusting the telescopic position (position in a front-rear direction) of a steering wheel according to the body size of each driver has been known. Such a steering apparatus includes an outer column that holds an inner pipe, which accommodates a steering shaft, so as to be movable and fixable in a vehicle front-rear direction. When a fastening lever is turned, fastening with respect to the outer column is released, and the telescopic position of the steering wheel can be adjusted.

When a large load in a radial direction is applied to the steering wheel in a state where the inner pipe is fastened to the outer column, for example, when a driver strongly pushes down the steering wheel in the radial direction, a phenomenon in which the inner pipe is slightly displaced in the radial direction may occur. To suppress this displacement phenomenon, increasing the rigidity of the outer column can be considered. As a technology for increasing the rigidity of the outer column, for example, Japanese Unexamined Patent Publication No. 2022-129186 is known.

A steering apparatus known from Japanese Unexamined Patent Publication No. 2022-129186 includes an outer column that holds an inner pipe, which accommodates a steering shaft, so as to be movable and fixable in a vehicle front-rear direction. The outer column is an integrally formed article composed of a cylindrical portion into which the inner pipe is fitted, and a housing having a rectangular shape and formed integrally with one end of the cylindrical portion. The housing holds the inner pipe so as to be movable and fixable in the vehicle front-rear direction. Furthermore, the steering apparatus includes two side plates that sandwich the housing therebetween in a vehicle width direction, and a fastening member for fastening the two side plates. By operating an operating lever, the fastening member fastens the two side plates to sandwich the housing therebetween in the vehicle width direction, so that the inner pipe is fixed to the housing.

The housing includes three types of slits and a movable portion. The three types of slits include a first slit penetrating through the housing in the vehicle width direction; two second slits intersecting the first slit; and a third slit extending in an axial direction of the housing. The fastening member for fastening the two side plates penetrates through the first slit. The movable portion is swingable, is disposed between the two second slits, and is in contact with the side plates. The two second slits and the movable portion are provided only on one side of the housing in the vehicle width direction. When the two side plates are fastened by the fastening member, the movable portion swings and a portion in which the movable portion is not provided does not swing.

The rigidity of the outer column can be increased by partially increasing the wall thickness of the housing.

### SUMMARY OF THE INVENTION

The steering apparatus known from Japanese Unexamined Patent Publication No. 2022-129186 is configured such that the housing having a rectangular shape is formed in the outer column, and the three types of slits and the movable portion are formed in the housing. The outer column has a complicated shape, and inevitably becomes relatively large. Therefore, in the conventional technology, there is still room for improvement in terms of reducing the size or weight of the steering apparatus.

An object of the invention is to provide a technology capable of reducing the size or weight of a steering apparatus while increasing the rigidity of an outer column, and improving the layout flexibility of the steering apparatus with respect to a vehicle body.

According to a first aspect of the present disclosure, there is provided a steering apparatus including an inner pipe that accommodates and rotatably supports a steering shaft; and an outer column including a pair of clamp portions that hold the inner pipe so as to be movable and fixable in a vehicle front-rear direction. The outer column includes a holding cylinder that holds the inner pipe, an upper extension portion extending from an upper portion of the holding cylinder toward a front of a vehicle body, a lower extension portion extending from a lower portion of the holding cylinder toward the front of the vehicle body, and a support portion formed integrally with a front end of the upper extension portion and a front end of the lower extension portion and supporting the steering shaft. The support portion is coupled to a vehicle body support bracket via pivots so as to be swingable up and down. A space between the upper extension portion and the lower extension portion penetrates entirely from the holding cylinder to the support portion in a vehicle width direction.

According to a second aspect, preferably, in the steering apparatus according to the first aspect, the vehicle body support bracket includes a bracket portion extending from the pivots toward the holding cylinder while covering an upper side of the upper extension portion. The bracket portion has a pair of insertion grooves through which fastening members for fastening to the vehicle body can be inserted in a vehicle body up-down direction. The pair of insertion grooves are located on both sides in a direction along a center line of the pivots with respect to an axis of the holding cylinder. A width of the upper extension portion and a width of the lower extension portion are smaller than a spacing between the pair of insertion grooves.

According to a third aspect, preferably, in the steering apparatus according to the first or second aspect, the upper extension portion and the lower extension portion are parallel to an axis of the holding cylinder, and the pivots are located on an extension line of the upper extension portion.

According to a fourth aspect, preferably, the steering apparatus according to the first to third aspects further includes a restriction bracket that adjusts and restricts a position of the inner pipe in the vehicle front-rear direction relative to the outer column. The restriction bracket includes a friction plate bracket portion capable of generating a frictional force with outer surfaces of the pair of clamp portions by fastening of a clamping bolt, and a restriction portion located between the pair of clamp portions to overlap an outer peripheral surface of the inner pipe and extending along a longitudinal direction of the inner pipe. The restriction portion has an elongated hole along the longitudinal direction of the inner pipe, and is coupled while restricting a relative displacement of the inner pipe in the longitudinal direction by friction against the outer peripheral surface of the inner pipe generated by a fastening force of a coupling bolt passing through the elongated hole. The lower extension portion has an elongated hole extending continuously from an opening between the pair of clamp portions toward the support portion. At least a part of the restriction portion is inserted into the elongated hole.

According to a fifth aspect, preferably, the steering apparatus according to the first to third aspects further includes a restriction bracket that adjusts and restricts a position of the inner pipe in the vehicle front-rear direction relative to the outer column. The restriction bracket includes a friction plate bracket portion that is a U-shaped member formed from a sheet material and that is capable of generating a frictional force with outer surfaces of the pair of clamp portions by fastening of a clamping bolt, and a restriction portion that is an inverted U-shaped member formed from a sheet material, the restriction portion being located between the pair of clamp portions to overlap an outer peripheral surface of the inner pipe and extending along a longitudinal direction of the inner pipe. The restriction portion has an elongated hole along the longitudinal direction of the inner pipe, and is coupled while restricting a relative displacement of the inner pipe in the longitudinal direction by friction against the outer peripheral surface of the inner pipe generated by a fastening force of a coupling bolt passing through the elongated hole. The restriction portion is formed as a member separate from the friction plate bracket portion. The restriction portion is assembled to the friction plate bracket portion.

The present disclosure can provide a technology capable of reducing the size or weight of the steering apparatus while increasing the rigidity of the outer column, and improving the layout flexibility of the steering apparatus with respect to the vehicle body.

### BRIEF DESCRIPTION OF THE DRAWINGS

FIG. 1 is a left side view of a steering apparatus according to an embodiment;

FIG. 2 is a perspective view of the steering apparatus illustrated in FIG. 1, as viewed from above;

FIG. 3 is a cross-sectional view taken along line 3-3 in FIG. 2;

FIG. 4 is an enlarged cross-sectional view of the front half portion of the steering apparatus illustrated in FIG. 3;

FIG. 5 is a view taken in the direction of arrow 5 in FIG. 2;

FIG. 6 is a perspective view of an outer column illustrated in FIG. 5;

FIG. 7A is a view taken in the direction of arrow 7A in FIG. 6, FIG. 7B is a view taken in the direction of arrow 7B in FIG. 7A, and FIG. 7C is a view taken in the direction of arrow 7C in FIG. 7B;

FIG. 8A is a left side view of a portion in which a support portion illustrated in FIG. 1 is mounted to a vehicle body by a vehicle body mounting bracket, and FIG. 8B is a cross-sectional view taken along line 8B-8B in FIG. 8A;

FIG. 9 is a plan view of the steering apparatus illustrated in FIG. 1;

FIG. 10 is a cross-sectional view taken along line 10-10 in FIG. 1;

FIG. 11 is a cross-sectional view illustrating a relationship among an inner pipe, a holding cylinder, the vehicle body support bracket, and a restriction bracket illustrated in FIG. 10;

FIG. 12A is a cross-sectional view illustrating a relationship between the inner pipe and the restriction bracket illustrated in FIG. 4, and FIG. 12B is a cross-sectional view taken along line 12B-12B in FIG. 12A;

FIG. 13 is a perspective view of the restriction bracket illustrated in FIG. 12A; and

FIG. 14 is an exploded view of the restriction bracket illustrated in FIG. 13.

### DETAILED DESCRIPTION OF THE PREFERRED EMBODIMENTS

An embodiment of the invention will be described below with reference to the accompanying drawings. A mode illustrated in the accompanying drawings is merely one example of the invention, and the invention is not limited to the mode. In the following description, the terms “left” and “right” refer to the left and right as viewed from the driver of a vehicle, and the terms “front” and “rear” refer to the front and rear with respect to the traveling direction of the vehicle. In addition, in the drawings, Fr indicates front or forward, Rr indicates rear or rearward, Le indicates left as viewed from the driver, Ri indicates right as viewed from the driver, Up indicates upward or upper side, Dn indicates downward or lower side, R1 indicates a vehicle front-rear direction (a front-rear direction of a steering apparatus), R2 indicates a vehicle width direction (a left-right direction of the steering apparatus), and R3 indicates a vehicle up-down direction (an up-down direction of the steering apparatus).

### Steering Apparatus 10

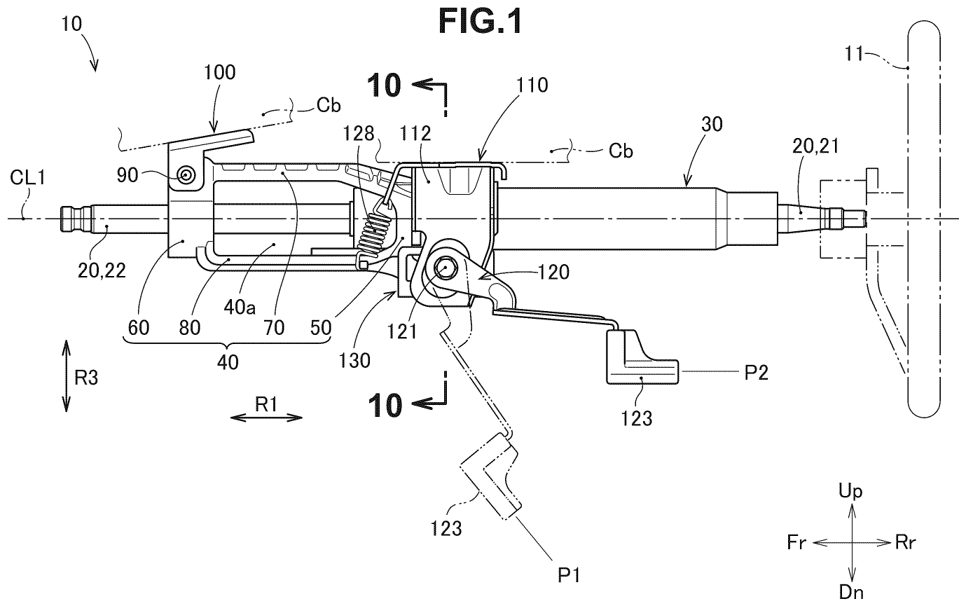

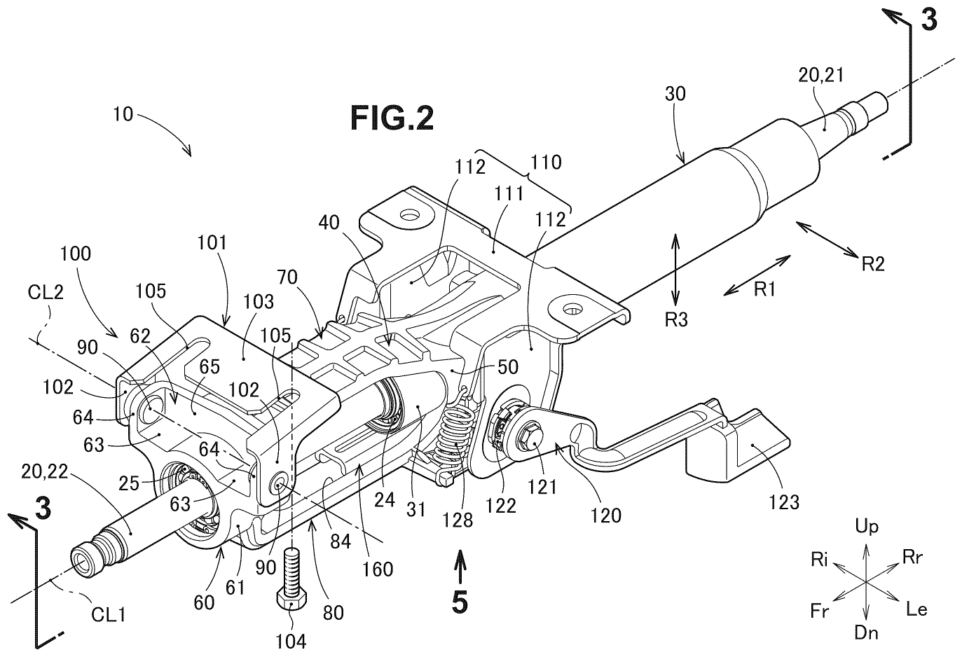

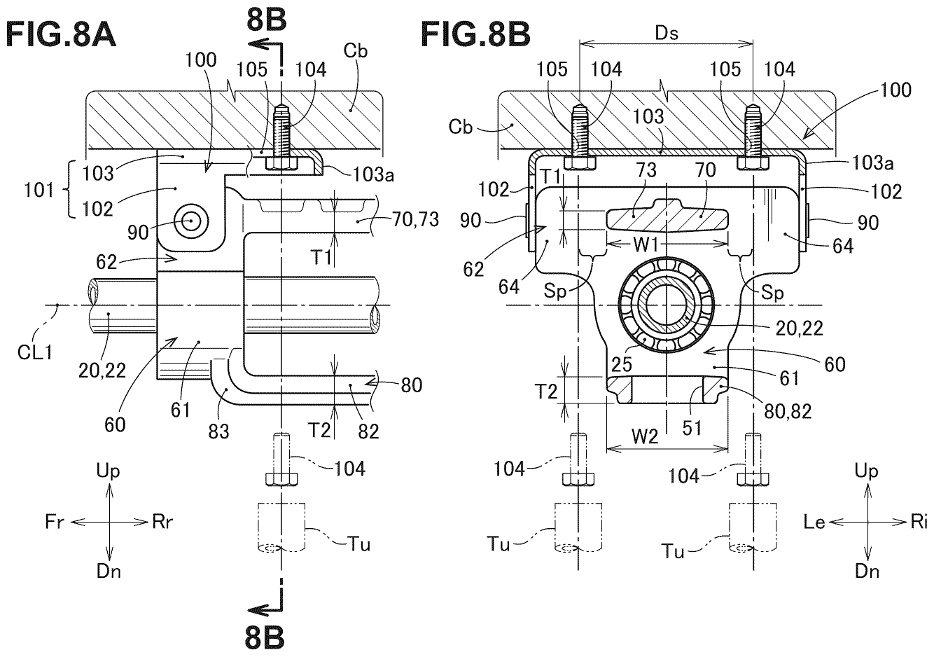

Referring to FIG. 1 and FIG. 2, a steering apparatus 10 has a telescopic adjustment function and a tilt adjustment function. The telescopic adjustment function is a function that allows the driver to adjust the position of a steering wheel 11 in the vehicle front-rear direction R1 according to the body size of the driver in a state where the steering apparatus 10 is mounted to a vehicle body Cb (see FIG. 8A). The tilt adjustment function is a function that allows the driver to adjust the inclination of the steering wheel 11 in the vehicle up-down direction R3 relative to the vehicle body Cb according to the body size of the driver in a state where the steering apparatus 10 is mounted to the vehicle body Cb.

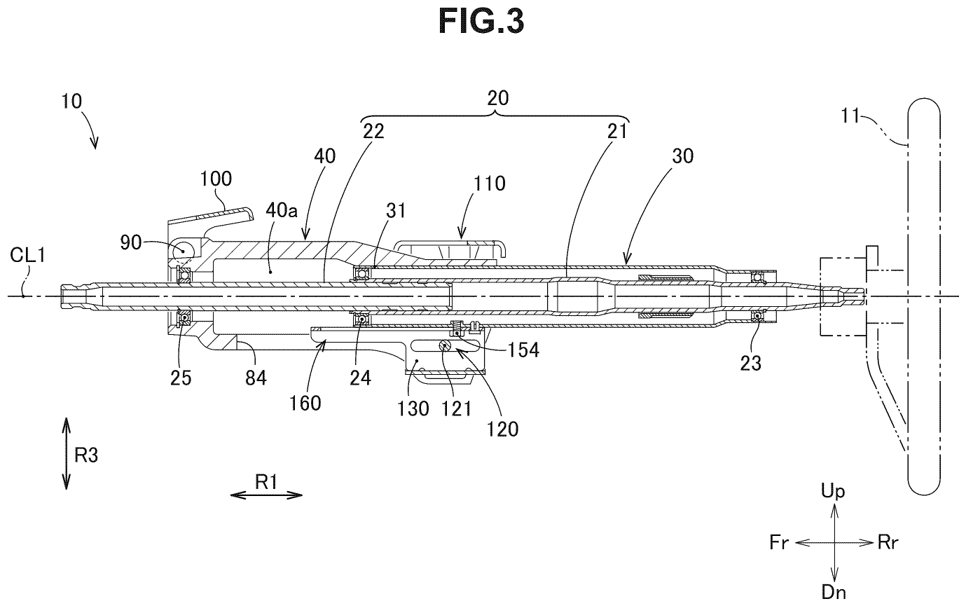

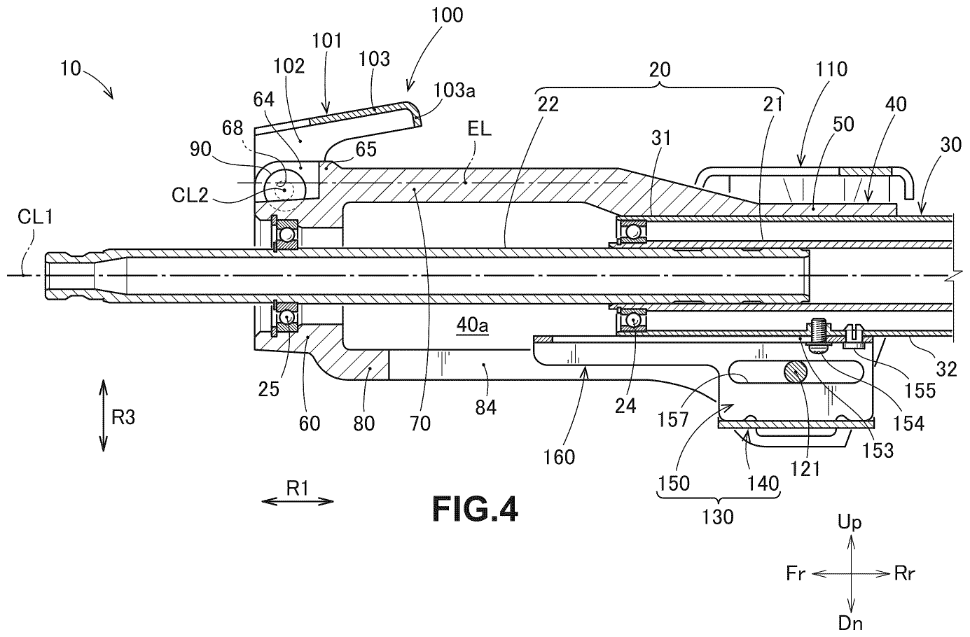

Referring to FIG. 3 and FIG. 4, the steering apparatus 10 includes a steering shaft 20 to which the steering wheel 11 is mounted; an inner pipe 30 having a cylindrical shape that accommodates at least a part of the steering shaft 20; and an outer column 40 that holds the inner pipe 30 so as to be movable and fixable in the vehicle front-rear direction R1.

Furthermore, the steering apparatus 10 includes a vehicle body support bracket 100 (front bracket 100) that supports the front end portion of the outer column 40 so as to be swingable in the up-down direction R3 and is mountable to the vehicle body Cb, and a vehicle body mounting bracket 110 (rear bracket 110) that supports the rear end portion of the outer column 40 so as to be tilt-adjustable and is mountable to the vehicle body Cb.

Furthermore, the steering apparatus 10 includes a fastening mechanism 120 capable of fastening the inner pipe 30 to the outer column 40, and a restriction bracket 130 that adjusts and restricts the position of the inner pipe 30 in the vehicle front-rear direction R1 relative to the outer column 40.

### Steering Shaft 20

As illustrated in FIG. 3 and FIG. 4, the steering shaft 20 has a two-piece structure composed of an input shaft 21 in which the steering wheel 11 is attached to the rear end portion thereof, and an output shaft 22 coupled to the front end portion of the input shaft 21. The input shaft 21 and the output shaft 22 are located linearly on an axis CL1 of the steering shaft 20. The steering shaft 20 may be formed as a single component instead of having a two-piece structure.

The rear portion of the steering shaft 20 is rotatably supported by a first bearing 23 at the rear end of the inner peripheral surface of the inner pipe 30. An intermediate portion of the steering shaft 20 is rotatably supported by a second bearing 24 at the front end of the inner peripheral surface of the inner pipe 30. The front portion of the steering shaft 20 is rotatably supported by a third bearing 25 on the inner peripheral surface of a support portion 60 provided at the front end of the outer column 40.

### Inner Pipe 30

The front end portion 31 of the inner pipe 30 is located at a longitudinal center of the outer column 40.

### Outer Column 40

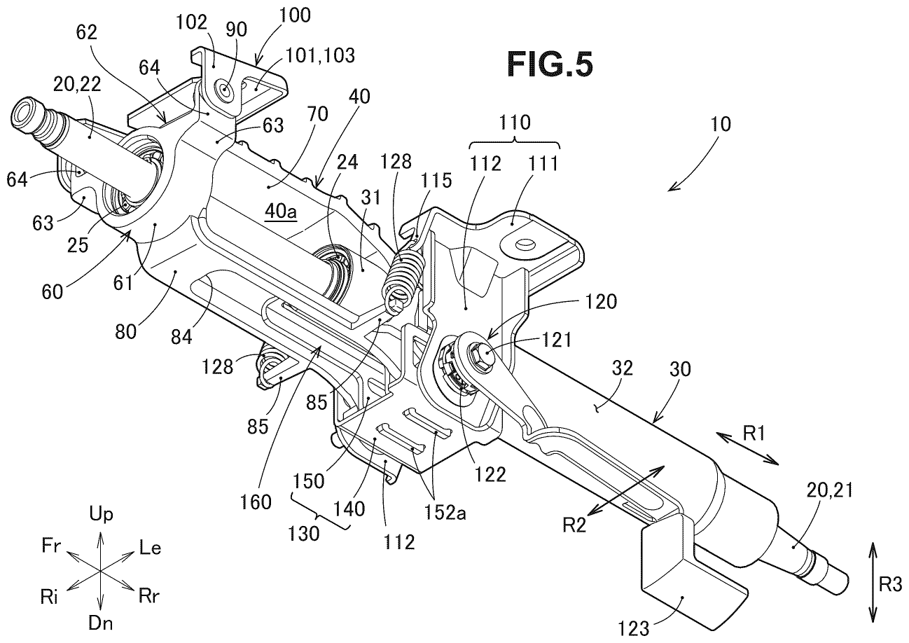

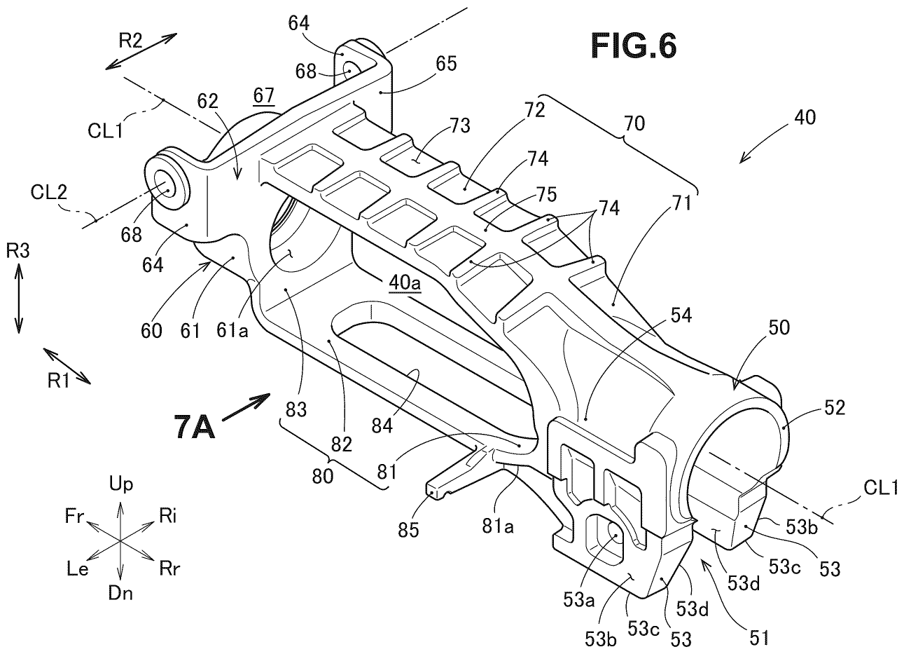

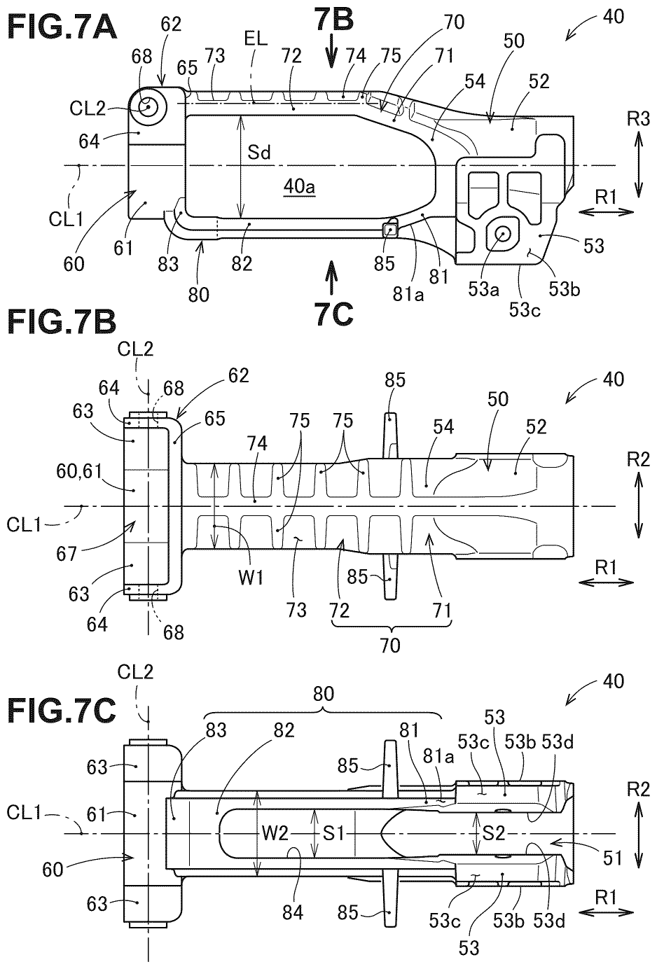

Referring to FIG. 5 and FIG. 6, it is preferable that the outer column 40 is a die-cast article of a metal material such as an aluminum alloy in order to achieve both weight reduction and high rigidity. The outer column 40 is an integrally formed member composed of a holding cylinder 50 that holds the inner pipe 30; the support portion 60 located at the front Fr of the holding cylinder 50; and upper and lower extension portions 70 and 80 connecting the holding cylinder 50 and the support portion 60. Referring also to FIG. 7A, one of the upper and lower extension portions 70 and 80 is the upper extension portion 70 located above the axis CL1 of the steering shaft 20. The other of the upper and lower extension portions 70 and 80 is the lower extension portion 80 located below the axis CL1 of the holding cylinder 50 The axis CL1 of the steering shaft 20 may be referred to as the “axis CL1 of the holding cylinder 50” as appropriate.

Referring to FIG. 6 to FIG. 7C, the overall shape of the holding cylinder 50 is an inverted U-shape as viewed from the steering wheel 11 side (see FIG. 1). That is, the holding cylinder 50 having a cylindrical shape is composed of a pipe holding portion 52 having a cylindrical shape and a slit 51 (hereinafter, referred to as an opening 51) at a lower portion thereof, and a pair of clamp portions 53 and 53 extending downward (Dn) from the pipe holding portion 52 on both sides of the opening 51 in a width direction R2. The pipe holding portion 52 is centered on the axis CL1 of the holding cylinder 50. The opening 51 and the pair of clamp portions 53 and 53 are provided along the axis CL1 over the entire length of the holding cylinder 50 in the front-rear direction R1. The opening 51 penetrates through the holding cylinder 50 from the inside to the outside. The pair of clamp portions 53 and 53 are flat plate-shaped portions facing each other, and extend downward (Dn) from the pipe holding portion 52 on both sides of the opening 51 in the width direction R2.

Referring also to FIG. 5, in this way, the holding cylinder 50 includes the pipe holding portion 52 capable of holding the outer peripheral surface 32 of the inner pipe 30; the opening 51 formed along the axial direction of the pipe holding portion 52; and the pair of clamp portions 53 and 53 extending downward (Dn) from the pipe holding portion 52 on both sides of the opening 51 in the width direction R2.

The pair of clamp portions 53 and 53 are portions that sandwich the inner pipe 30 therebetween so as to be movable and fixable in the vehicle front-rear direction R1. The pair of clamp portions 53 and 53 have a pair of bolt insertion holes 53a and 53a penetrating therethrough in the vehicle width direction R2, respectively.

The second bearing 24 that supports the intermediate portion of the steering shaft 20 is supported by the front end portion 31 of the inner pipe 30.

The support portion 60 is a portion that is coupled to the vehicle body support bracket 100 via pivots 90 and 90 (support shafts 90 and 90) so as to be swingable up and down. The support portion 60 includes a support portion main body 61 having a cylindrical shape, and a pivot support portion 62 formed integrally with the upper portion of the support portion main body 61. The support portion main body 61 is centered on the axis CL1 of the holding cylinder 50, and the third bearing 25 is fitted into the inner peripheral surface 61a. The front portion of the steering shaft 20 is supported by the support portion 60 via the third bearing 25.

Referring to FIG. 5 to FIG. 7C, the pivot support portion 62 includes, for example, a pair of base portions 63 and 63 extending from the upper portion of the support portion main body 61 toward both sides in the vehicle width direction R2; a pair of upright portions 64 and 64 erected upward (Up) from the distal ends of the base portions 63 and 63; and a connecting portion 65 connecting the upright portions 64 and 64. The pair of base portions 63 and 63 are formed as horizontal plate-shaped portions. The pair of upright portions 64 and 64 are formed as vertical plate-shaped portions having the plate surfaces facing each other. The connecting portion 65 is formed as a vertical plate-shaped portion that is formed so as to be continuous with the upper portion of the support portion main body 61, the rear ends of the pair of base portions 63 and 63, and the rear ends of the pair of upright portions 64 and 64.

In this way, since the pivot support portion 62 has a space portion 67 (see FIG. 7B) surrounded by the base portions 63 and 63, the upright portions 64 and 64, and the connecting portion 65, the pivot support portion 62 is lighter than in a case where the pivot support portion 62 is entirely solid. It is preferable that the upper ends of the pair of upright portions 64 and 64 and the upper end of the connecting portion 65 are set at the same height relative to the axis CL1 of the holding cylinder 50. The size of the holding cylinder 50 can be reduced compared to a case where one of the upper ends of the pair of upright portions 64 and 64 and the upper end of the connecting portion 65 is high.

Furthermore, the pair of upright portions 64 and 64 have a pair of pivot holes 68 and 68 into which the pivots 90 and 90 can be fitted. The pivot holes 68 and 68 are located at an upper position (upper side Up) relative to the axis CL1 of the holding cylinder 50, and penetrate through the upright portions 64 and 64 in the vehicle width direction R2. A center line CL2 of the pivot holes 68 and 68 (pivots 90 and 90) is orthogonal to the axis CL1 of the holding cylinder 50. The pair of pivots 90 and 90 may be formed as a single member.

Referring to FIG. 6 to FIG. 7C, the upper extension portion 70 extends from the upper portion of the holding cylinder 50 toward the front Fr. More specifically, the upper extension portion 70 is composed of a first upper extension portion 71 extending forward and upward from the front upper portion of the holding cylinder 50, and a second upper extension portion 72 extending horizontally forward (Fr) from the front end of the first upper extension portion 71 to the support portion 60.

The front end of the second upper extension portion 72 is located on the center line CL2 of the pivot holes 68 and 68 (pivots 90 and 90), and is formed integrally with the rear surface 65a of the connecting portion 65. A straight line EL passing through the middle of the second upper extension portion 72 in a thickness direction (up-down direction R3) and extending along the axis CL1 of the holding cylinder 50 is referred to as an “extension line EL of the upper extension portion 70”. The pivots 90 and 90 are located on the extension line EL of the second upper extension portion 72. For this reason, when a load in the vehicle front-rear direction R1 acts on the pivots 90 and 90 from the upper extension portion 70, the load can be sufficiently received by the pivots 90 and 90.

The pivots 90 and 90 are located above the upper surface of the pipe holding portion 52. In order to accommodate a difference in height between the upper surface of the pipe holding portion 52 and the pivots 90 and 90, the first upper extension portion 71 extends forward and upward from the front end portion of the holding cylinder 50. For this reason, the load can be smoothly transmitted from the pipe holding portion 52 to the pivots 90 and 90 via the upper extension portion 70, and the tilting operation (inclination operation in the vehicle up-down direction R3) of the steering apparatus 10 becomes smooth.

When the outer column 40 is viewed from above, the first upper extension portion 71 has a tapered shape that narrows from the front upper portion of the holding cylinder 50 toward the front, and the second upper extension portion 72 extends from the front end of the first upper extension portion 71 with a constant width. The second upper extension portion 72 has a flat shape in the up-down direction R3. The width of the second upper extension portion 72 is W1 (the width W1 of the upper extension portion 70), and the thickness T1 of the second upper extension portion 72 is uniform.

On the upper surface 73 of the upper extension portion 70, one first rib 74 extending in a longitudinal direction R1 (a direction along the axis CL1 of the holding cylinder 50 and the front-rear direction R1) of the upper extension portion 70 and a plurality of second ribs 75 extending in the width direction R2 (left-right direction R2) of the upper extension portion 70 are integrally formed. The first rib 74 and each of the second ribs 75 are formed as vertical ribs erected from the upper surface 73 of the upper extension portion 70. In this way, it is preferable that the rigidity (bending rigidity and torsional rigidity) of the upper extension portion 70 is increased by the first rib 74 and each of the second ribs 75. The upper extension portion 70 may not configured not to include the first rib 74 or each of the second ribs 75 (reinforcing rib 74 or 75).

The lower extension portion 80 extends from the lower portion of the holding cylinder 50 toward the front Fr of the vehicle body. More specifically, the lower extension portion 80 is composed of a first lower extension portion 81 extending forward and downward from the front lower portion of the holding cylinder 50; a second lower extension portion 82 extending horizontally from the front end of the first lower extension portion 81 toward the front Fr; and a third lower extension portion 83 extending vertically from the front end of the second lower extension portion 82 to the rear lower portion of the support portion 60.

The first lower extension portion 81 has a flat shape in the up-down direction R3. The second lower extension portion 82 has a flat shape in the front-rear direction R1. When the outer column 40 is viewed from below, the first lower extension portion 81, the second lower extension portion 82, and the third lower extension portion 83 have a constant width W2. That is, the width of the lower extension portion 80 is W2. The thickness of the second lower extension portion 82 and the third lower extension portion 83 is T2.

The upper extension portion 70 and the lower extension portion 80 vertically face each other with respect to the axis CL1 of the holding cylinder 50. A separation distance between the upper extension portion 70 and the lower extension portion 80 is Sd. Moreover, the upper extension portion 70 and the lower extension portion 80 are parallel to the axis CL1 of the holding cylinder 50. That is, the second upper extension portion 72 of the upper extension portion 70 and the second lower extension portion 82 of the lower extension portion 80 are parallel to the axis CL1 of the holding cylinder 50.

The space between the upper extension portion 70 and the lower extension portion 80 penetrates entirety from the holding cylinder 50 to the support portion 60 in the vehicle width direction R2. Therefore, the outer column 40 has a cavity 40a penetrating in the left-right direction R2 between the upper extension portion 70 and the lower extension portion 80. The outer column 40 becomes lighter by that amount.

The pair of clamp portions 53 and 53 of the holding cylinder 50 extend from the pipe holding portion 52 to the lower surface 81a of the first lower extension portion 81, and are formed integrally with the lower surface 81a. The lower extension portion 80 has a slit 84 (elongated hole 84) communicating with the opening 51 between the pair of clamp portions 53 and 53. The slit 84 penetrates through the lower extension portion 80 in the up-down direction R3, and is continuous linearly from the opening 51 toward the support portion 60 up to the vicinity of the third lower extension portion 83. The width S1 of the slit 84 is set to be at least equal to the width S2 of the opening 51. For this reason, a restriction portion 150 of the restriction bracket 130 to be described later is capable of smoothly moving the opening 51 and the slit 84 in the front-rear direction R1.

Furthermore, the lower extension portion 80 includes lower spring hook portions 85 and 85 both sides in the vehicle width direction R2.

As described above, the support portion 60 is coupled to the vehicle body support bracket 100 via the pivots 90 and 90 so as to be swingable up and down. As a result, the front end portion of the outer column 40 is supported on the vehicle body Cb by the vehicle body support bracket 100.

### Vehicle Body Support Bracket 100

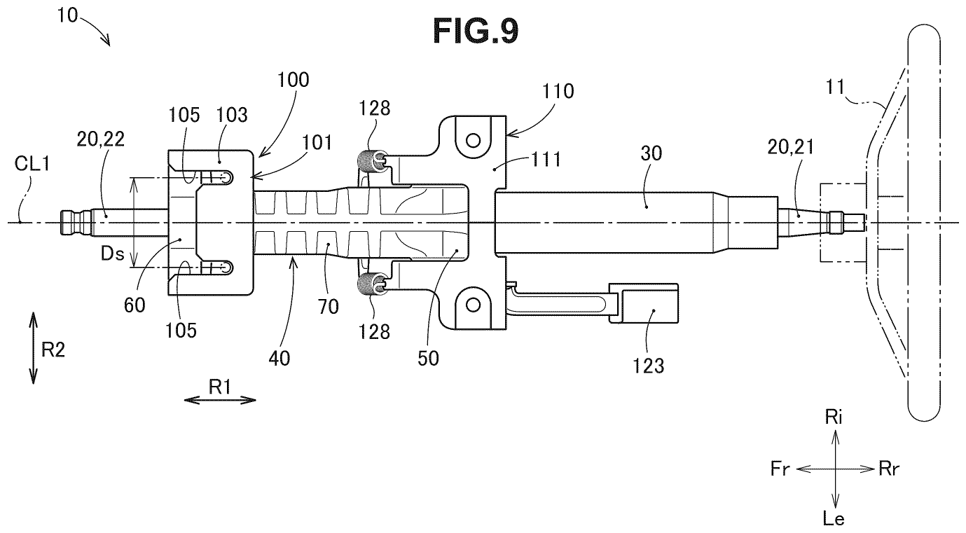

Referring to FIG. 2 and FIG. 8A to FIG. 9, the vehicle body support bracket 100 is formed as, for example, a press-formed article of a sheet material. The vehicle body support bracket 100 includes a bracket portion 101 extending from the pivots 90 and 90 toward the holding cylinder 50 while covering the upper side of the upper extension portion 70. The bracket portion 101 includes a pair of leg portions 102 and 102 that overlap the outer surfaces of the upright portions 64 and 64 of the pivot support portion 62, and a bracket main body 103 connecting the upper ends of the leg portions 102 and 102.

The pair of leg portions 102 and 102 are vertical plate-shaped portions extending upward (Up) along the outer surfaces of the upright portions 64 and 64, and are swingably coupled to the upright portions 64 and 64 via the pivots 90 and 90.

The bracket main body 103 is a horizontal plate-shaped portion extending rearward (Rr) from the upper ends of the leg portions 102 and 102, and is formed integrally with the leg portions 102 and 102. Furthermore, the bracket main body 103 extends from the pivots 90 and 90 toward the holding cylinder 50 while covering the upper side of the upper extension portion 70. The bracket main body 103 is configured to be high rigid by including a bent edge portion 103a along the peripheral edge thereof.

The bracket main body 103 has a pair of insertion grooves 105 and 105 through which a pair of fastening members 104 such as bolts for fastening to the vehicle body Cb can be inserted in a vehicle body up-down direction R3. When the holding cylinder 50 is viewed from above, the pair of insertion grooves 105 and 105 are located on both sides in a direction along the center line CL2 of the pivots 90 and 90 (left-right direction R2) with respect to the axis CL1 of the holding cylinder 50. The pair of insertion grooves 105 and 105 may have any configuration as long as the pair of fastening members 104 can be inserted therethrough in the up-down direction R3. For example, the pair of insertion grooves 105 and 105 are parallel to the axis CL1 of the holding cylinder 50, and examples of the insertion grooves 105 and 105 include a groove (cutout hole) that is open to the front Fr or the rear Rr and a groove (elongated hole), both the front Fr and the rear Rr of which are closed. When the holding cylinder 50 is viewed from above, the pair of insertion grooves 105 and 105 may be inclined with respect to the axis CL1 of the holding cylinder 50.

The bracket main body 103 is mountable to the vehicle body Cb by the fastening members 104 such as bolts inserted through the insertion grooves 105 and 105. A spacing Ds between the pair of insertion grooves 105 and 105 is set to be larger than the width W1 of the second upper extension portion 72 and the width W2 of the second lower extension portion 82. The width W1 of the second upper extension portion 72 is equal to the width W2 of the second lower extension portion 82. A space Sp having a size of one-half of a difference between the width W1 of the second upper extension portion 72 and the spacing Ds between the pair of insertion grooves 105 and 105 is referred to as a “fastening space Sp” or a “working space Sp”. The size of the fastening space Sp is set to a size that allows a tool Tu to fasten the fastening members 104 and 104 inserted through the insertion grooves 105 and 105. The steering apparatus 10 can be easily assembled to the vehicle body Cb by having the fastening space Sp.

### Vehicle Body Mounting Bracket 110

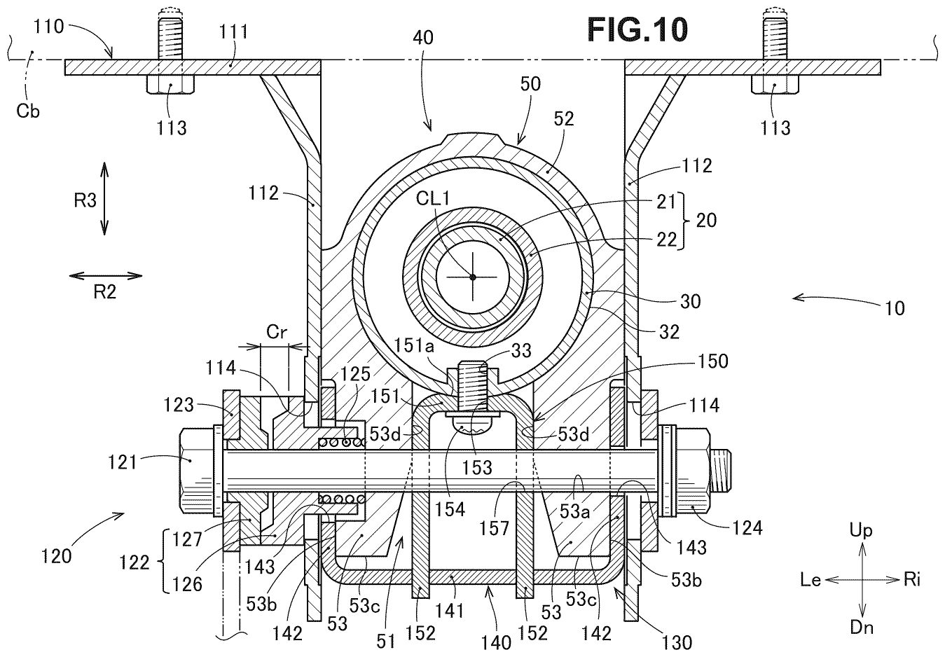

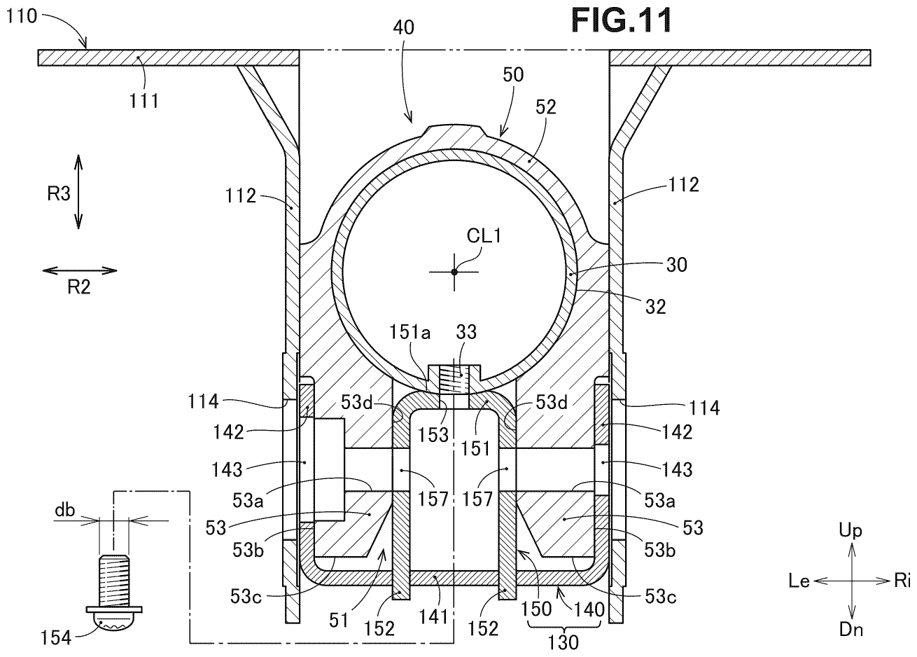

Referring to FIG. 1, FIG. 10, and FIG. 11, the vehicle body mounting bracket 110 includes a bracket main body 111 having a horizontal plate shape and mountable to the vehicle body Cb, and a pair of outer column support portions 112 and 112 (side plate portions 112 and 112), each having a vertical plate shape and extending downward (Dn) from both sides of the bracket main body 111 in the width direction R2. The bracket main body 111 is fastened to the vehicle body Cb by fastening members 113 and 113 such as bolts. The pair of outer column support portions 112 and 112 are flat plate-shaped members facing each other in parallel, and elongated holes 114 and 114 for tilt adjustment that are elongated in the up-down direction R3 are formed in the pair of outer column support portions 112 and 112, respectively. The vehicle body mounting bracket 110 includes upper spring hook portions 115 and 115 (see FIG. 5) on both sides in the vehicle width direction R2.

The pair of clamp portions 53 and 53 are located between the pair of outer column support portions 112 and 112 of the vehicle body mounting bracket 110. The outer surfaces 53b and 53b of the pair of clamp portions 53 and 53 of the holding cylinder 50 in the vehicle width direction R2 are adjacent to the inner surfaces of the pair of outer column support portions 112 and 112 in the vehicle width direction R2. The pair of outer column support portions 112 and 112 are capable of sandwiching both sides of the pair of clamp portions 53 and 53 in the width direction R2 therebetween.

### Fastening Mechanism 120

Referring to FIG. 10 and FIG. 11, the fastening mechanism 120 is capable of fastening the pair of clamp portions 53 and 53. The fastening mechanism 120 includes a clamping bolt 121, a fastening cam 122, an operating lever 123, a nut 124, and a compression coil spring 125.

The clamping bolt 121 penetrates through each of the elongated holes 114 and 114 of the pair of outer column support portions 112 and 112 and each of the insertion holes 53a and 53a of the pair of clamp portions 53 and 53. The outer column 40 is supported on the vehicle body mounting bracket 110 by the clamping bolt 121. The clamping bolt 121 is capable of fastening the inner pipe 30 via the pair of clamp portions 53 and 53 and the pair of outer column support portions 112 and 112.

The fastening cam 122 and the operating lever 123 are located outside one of the pair of outer column support portions 112 and 112 in the vehicle width direction, for example, outside the left outer column support portion 112 as viewed from the steering wheel 11 side. The nut 124 is located outside the other outer column support portion 112 in the vehicle width direction, and is screwed onto the clamping bolt 121.

The fastening cam 122 is composed of a fixed cam 126 and a movable cam 127 facing each other. The facing surfaces of the fixed cam 126 and the movable cam 127, which face each other, have respective cam lobes. The clamping bolt 121 penetrates through the fixed cam 126 and the movable cam 127. The fixed cam 126 is fitted into the elongated hole 114 of the left outer column support portion 112 as viewed from the steering wheel 11 side, so as to be slidable up and down and restricted from rotating. Furthermore, the fixed cam 126 is fitted to the clamping bolt 121 so as to be slidable in the left-right direction R2. The fixed cam 126 is biased by the compression coil spring 125 in a direction in which the fixed cam 126 meshes with the movable cam 127.

The operating lever 123 is an operating member for rotationally operating the clamping bolt 121. The operating lever 123 is mounted to the clamping bolt 121 so as to be rotatable with the movable cam 127.

When the operating lever 123 is at a movement position P1 indicated by an imaginary line in FIG. 1, the fixed cam 126 and the movable cam 127 is close to each other, and a spacing Cr is narrow. Accordingly, the fixation of the inner pipe 30 by the pipe holding portion 52 is released, so that the inner pipe 30 can be displaced in the vehicle front-rear direction R1. In this way, by turning the clamping bolt 121 in one direction to loosen the fastening mechanism 120, a movement mode in which the position of the inner pipe 30 in the vehicle front-rear direction R1 is adjustable relative to the outer column 40 can be set.

Thereafter, when the operating lever 123 is rotationally operated in a counterclockwise direction in FIG. 1 to switch to a restriction position P2 indicated by a solid line, the fixed cam 126 and the movable cam 127 are separated from each other, and the spacing Cr is widened. The pair of clamp portions 53 and 53 are pressed by the pair of outer column support portions 112 and 112 fastened by the fixed cam 126 and the nut 124, thereby deforming so as to approach each other. In this way, by turning the clamping bolt 121 in the other direction to fasten the fastening mechanism 120, a restriction mode in which the movement of the inner pipe 30 in the vehicle front-rear direction R1 relative to the outer column 40 can be set.

Referring to FIG. 5, a pair of tension springs 128 and 128 are hooked between the lower spring hook portions 85 and 85 of the lower extension portion 80 and the upper spring hook portions 115 and 115 of the vehicle body mounting bracket 110. The outer column 40 is suspended on both sides of the vehicle body mounting bracket 110 in the vehicle width direction R2 by the tension springs 128 and 128. When the clamping bolt 121 is loosened by the operating lever 123, the pair of tension springs 128 and 128 hold the outer column 40 by a biasing force.

As is apparent from the above description, the fastening mechanism 120 is capable of switching a state in which the inner pipe 30 is held by the outer column 40 between the restriction mode and the movement mode. That is, the fastening mechanism 120 switches between a restricted state in which movement of the inner pipe 30 in the longitudinal direction and the up-down direction relative to the outer column 40 is restricted and an allowed state in which such movement is allowed.

### Restriction Bracket 130

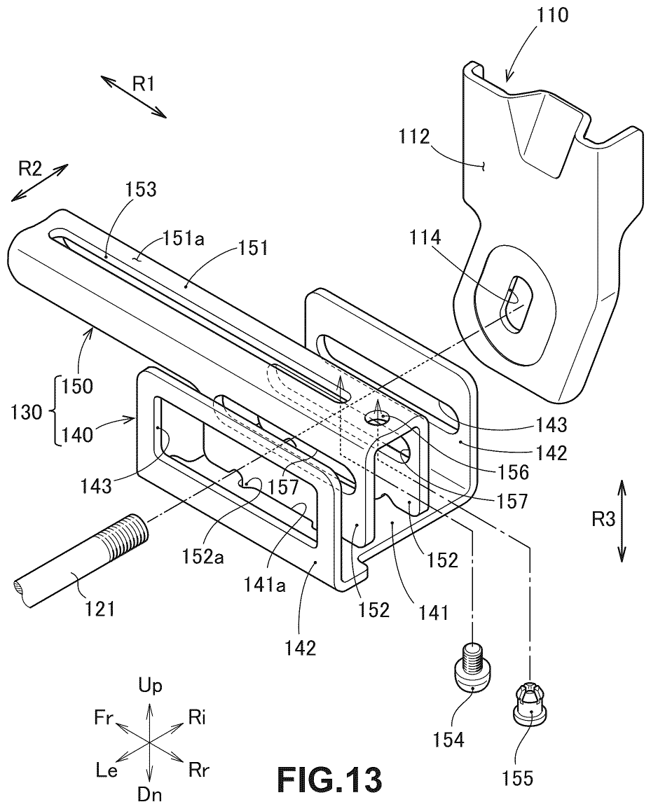

Referring to FIG. 10 to FIG. 13, the restriction bracket 130 adjusts and restricts the position of the inner pipe 30 in the vehicle front-rear direction R1 relative to the outer column 40, and has a structure in which a friction plate bracket portion 140 and a restriction portion 150 are combined. Each of the friction plate bracket portion 140 and the restriction portion 150 is formed of a bent article of a metal sheet.

The friction plate bracket portion 140 is a member capable of generating a frictional force with the outer surfaces 53b and 53b of the pair of clamp portions 53 and 53 by fastening of the clamping bolt 121. In detail, the friction plate bracket portion 140 is a U-shaped member, and is composed of a bottom plate 141 having a horizontal plate shape, and a pair of side plates 142 and 142 having a vertical plate shape and erected from both ends of the bottom plate 141 in the vehicle width direction R2. The bottom plate 141 is located below the lower ends 53c and 53c of the pair of clamp portions 53 and 53. The pair of side plates 142 and 142 have plate surfaces that are parallel to and face each other, and are interposed between the pair of clamp portions 53 and 53 and the pair of outer column support portions 112 and 112 so as to be being capable of sandwiched therebetween. Furthermore, the pair of side plates 142 and 142 have a pair of telescopic adjustment elongated holes 143 and 143 through which the clamping bolt 121 is capable of penetrating. The telescopic adjustment elongated holes 143 and 143 are elongated in the longitudinal direction of the inner pipe 30.

The restriction portion 150 is a member located between the pair of clamp portions 53 and 53 to overlap the outer peripheral surface 32 of the inner pipe 30 and extending along the longitudinal direction R1 of the inner pipe 30. In detail, the restriction portion 150 is an inverted U-shaped member, and is composed of a restriction plate 151 having a horizontal plate shape and overlapping the outer peripheral surface 32 of the inner pipe 30, and a pair of leg plates 152 and 152, each having a vertical plate shape and extending downward from both ends of the restriction plate 151 in the vehicle width direction R2 to at least the bottom plate 141 of the friction plate bracket portion 140.

A surface 151a (overlapping surface 151a) of the restriction plate 151, which overlaps the outer peripheral surface 32 of the inner pipe 30, is an arcuate surface conforming to the outer peripheral surface 32. For this reason, the restriction plate 151 can be brought into close contact with the outer peripheral surface 32 of the inner pipe 30. The restriction plate 151 has an elongated hole 153 along the longitudinal direction R1 (front-rear direction R1) of the inner pipe 30. The elongated hole 153 penetrates through the restriction plate 151 in a plate thickness direction. The restriction plate 151 is coupled while restricting the relative displacement of the inner pipe 30 in the longitudinal direction R1 by friction against the outer peripheral surface 32 of the inner pipe 30 generated by the fastening force of a coupling bolt 154 passing through the elongated hole 153.

The coupling bolt 154 passing through the elongated hole 153 penetrating through the restriction plate 151 is screwed into a screw hole 33 of the inner pipe 30 (is coupled to the inner pipe 30). The restriction plate 151 is assembled to the inner pipe 30 by the coupling bolt 154. That is, the restriction plate 151 is coupled while restricting the relative displacement of the inner pipe 30 in the longitudinal direction R1 by friction against the outer peripheral surface 32 of the inner pipe 30 generated by the fastening force of the coupling bolt 154 passing through the elongated hole 153.

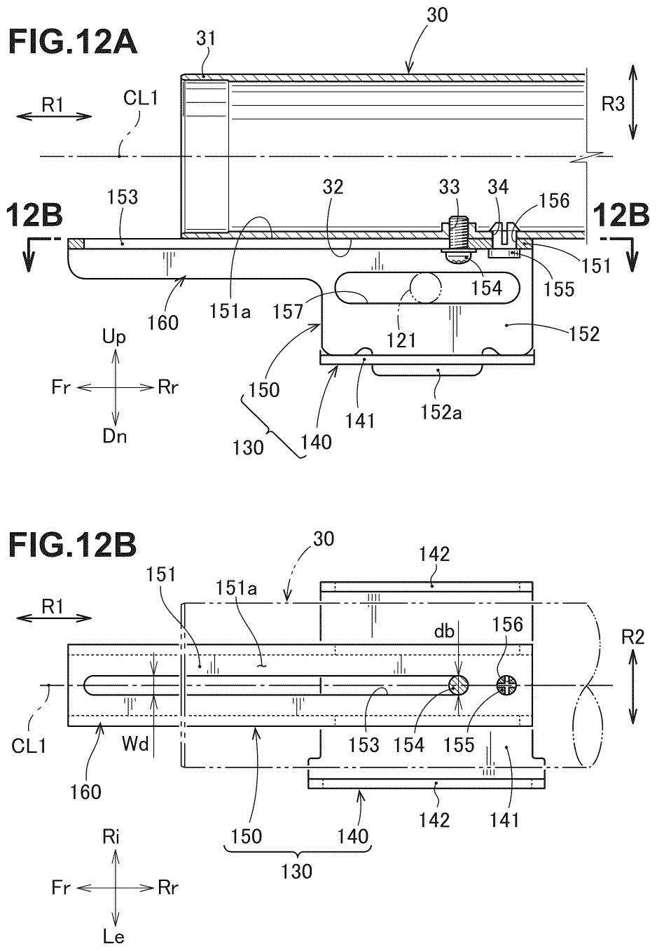

Referring to FIG. 12A and FIG. 12B, the width Wd of the elongated hole 153 is equal to or slightly larger than the diameter db of the shank portion of the coupling bolt 154. When the width Wd of the elongated hole 153 is excessively large relative to the diameter db of the shank portion of the coupling bolt 154, play may occur in the fixation of the restriction plate 151 to the inner pipe 30. The coupling bolt 154 slides along the elongated hole 153 in a forward movement direction Ad in the event of a secondary collision.

The width Wd of the elongated hole 153 may be smaller than the diameter db of the shank portion of the coupling bolt 154 (Wd<db). In that case, when the coupling bolt 154 slides in the forward movement direction Ad in the event of a secondary collision, the coupling bolt 153 enters while crushing the edge of the elongated hole 153.

Furthermore, a clip 155 made of resin is installed in the inner pipe 30 and the restriction plate 151 at a position rearward (Rr) of the elongated hole 153. The clip 155 is inserted through a clip insertion hole 34 penetrating through the outer peripheral surface 32 of the inner pipe 30 from the inside to the outside, and a clip insertion hole 156 penetrating through the overlapping surface 151a of the restriction plate 151 from the front to the back. The initial set position of the inner pipe 30 in the front-rear direction R1 relative to the restriction bracket 130 is determined by the clip 155. For this reason, the positioning work of the inner pipe 30 relative to the restriction bracket 130 is facilitated. When a collision force (collision energy) exceeding the frictional force between the inner pipe 30 and the restriction plate 151 is generated, the inner pipe 30 and the coupling bolt 154 moves in the forward movement direction Ad (vehicle front-rear direction R1) relative to the restriction bracket 130, thereby breaking the clip 155.

Referring to FIG. 10 to FIG. 13, the pair of leg plates 152 and 152 extend downward (Dn) from the restriction plate 151 along the inner surfaces 53d and 53d of the pair of clamp portions 53 and 53, and face the inner surfaces 53d and 53d of the pair of clamp portions 53 and 53. The leg plates 152 and 152 have plate surfaces that are parallel to and face each other. The pair of leg plates 152 and 152 have a pair of telescopic adjustment elongated holes 157 and 157 which are elongated in the longitudinal direction of the inner pipe 30 and through which the clamping bolt 121 is capable of penetrating. A relationship between the pair of clamp portions 53 and 53 and the pair of leg plates 152 and 152 is as follows. When the operating lever 123 is at the movement position P1 illustrated in FIG. 1 (during telescopic adjustment), the pair of leg plates 152 and 152 are not in contact with the inner surfaces 53d and 53d of the pair of clamp portions 53 and 53 or are in light contact therewith to such an extent that allows relative movement thereof. When the operating lever 123 is at the restriction position P2 illustrated in FIG. 1 (during fastening), the pair of leg plates 152 and 152 are fastened by the pair of clamp portions 53 and 53, so that relative movement thereof is restricted.

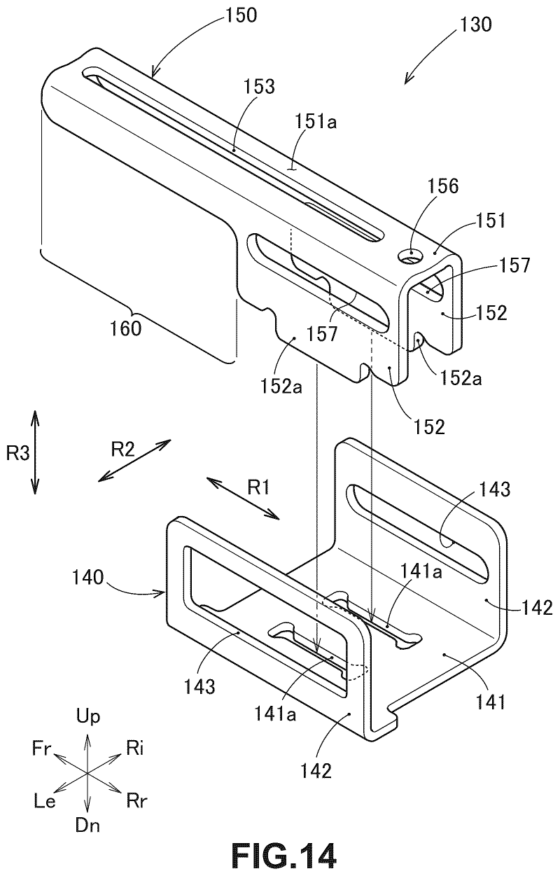

Referring to FIG. 14, as described above, the restriction portion 150 is formed as a member separate from the friction plate bracket portion 140, and is assembled to the friction plate bracket portion 140. For example, the friction plate bracket portion 140 and the restriction portion 150 can be configured to be assembled by the fitting of projections and recesses.

The pair of leg plates 152 and 152 of the restriction portion 150 include a pair of protruding pieces 152a and 152a protruding downward (Dn) from the lower ends of the pair of leg plates 152 and 152. The protruding pieces 152a and 152a are configured such that parts of the leg plates 152 and 152, each having a plate shape, protrude downward (Dn) as they are, and each has a rectangular shape in plan view that is elongated in the front-rear direction R1. The length of the protruding pieces 152a and 152a in the front-rear direction is Ln, and the plat thickness th of the protruding pieces 152a and 152a is equal to the plate thickness of the leg plates 152 and 152.

On the other hand, the bottom plate 141 of the friction plate bracket portion 140 has a pair of fitting holes 141a and 141a formed of through-holes into which the protruding pieces 152a and 152a can be fitted. Each of the fitting holes 141a and 141a has a rectangular shape in plan view that is elongated in the front-rear direction R1.

The restriction portion 150 is assembled to the friction plate bracket portion 140 by fitting the pair of protruding pieces 152a and 152a into the pair of fitting holes 141a and 141a. The “fit” between the fitting holes 141a and 141a and the protruding pieces 152a and 152a may be any of a “clearance fit”, an “interference fit”, and a “transition fit”; however, it is preferable that a “transition fit”, which is an intermediate fit between a clearance fit and an interference fit, is employed. In the case of a “transition fit”, the fitting holes 141a and 141a and the protruding pieces 152a and 152a can be easily assembled with each other, and can also be easily assembled to the pair of clamp portions 53 and 53.

Since the restriction bracket 130 is sandwiched between the pair of clamp portions 53 and 53 or the pair of outer column support portions 112 after being assembled to the holding cylinder 50 and the vehicle body mounting bracket 110, the restriction bracket 130 is not affected by the “fit” between the fitting holes 141a and 141a and the protruding pieces 152a and 152a.

Since the restriction bracket 130 of the present embodiment is configured such that the restriction portion 150 is formed as a member separate from the friction plate bracket portion 140 and is assembled to the friction plate bracket portion 140, the rigidity of each part can be more appropriately and easily set compared to a restriction bracket formed from a single sheet material as disclosed in PCT International Publication No. WO 2022/102359. For example, the rigidity can be improved by increasing the plate thickness of the restriction portion 150.

Referring to FIG. 4 and FIG. 12A, the size of the friction plate bracket portion 140 of the restriction bracket 130 is set within a range where the friction plate bracket portion 140 overlaps the clamp portions 53 and 53 of the holding cylinder 50 (see FIG. 6). In contrast, since the elongated hole 153 formed in the restriction plate 151 defines the amount of relative displacement of the coupling bolt 154 coupled to the inner pipe 30 in the longitudinal direction R1, the elongated hole 153 extends further forward (Fr) than the friction plate bracket portion 140. For this reason, the restriction plate 151 also extends further forward (Fr) than the friction plate bracket portion 140. That is, the upper half 160 (including the restriction plate 151 and the upper halves of the pair of leg plates 152 and 152) of the restriction portion 150 extends further forward (Fr) than the friction plate bracket portion 140, thereby overlapping the lower extension portion 80. The overlapping upper half 160 of the restriction portion 150 may be referred to as a “restriction extension portion 160”.

In order to accommodate this, at least a part (restriction extension portion 160) of the restriction portion 150 is inserted into the slit 84 (elongated hole 84) of the lower extension portion 80 from the opening 51 between the pair of clamp portions 53 and 53.

Referring to FIG. 1 and FIG. 10, next, the operation of the steering apparatus 10 when a secondary collision is transmitted from the steering wheel 11 to the inner pipe 30 in the restriction mode in which the operating lever 123 is switched to the restriction position P2 will be described.

Prior to receiving a secondary collision, in the restriction mode, the pair of side plates 142 and 142 of the friction plate bracket portion 140 are fastened by the pair of outer column support portions 112 and 112 (side plate portions 112 and 112) of the vehicle body mounting bracket 110 and the pair of clamp portions 53 and 53, so that the current positions of the pair of side plates 142 and 142 is maintained by the frictional force therebetween.

In addition, the restriction plate 151 overlaps the outer peripheral surface 32 of the inner pipe 30, and is coupled while restricting the relative displacement of the inner pipe 30 in the longitudinal direction by the frictional force against the outer peripheral surface 32 of the inner pipe 30 generated by the fastening force of the coupling bolt 154, so that the current position of the restriction plate 151 is maintained. That is, the restriction plate 151 is directly assembled to the outer peripheral surface 32 of the inner pipe 30.

Thereafter, in the event of a secondary collision, the collision energy is transmitted directly from the inner pipe 30 to the restriction plate 151, further from the restriction plate 151 to the leg plates 152 and 152, and then from the leg plates 152 and 152 to the side plates 142 and 142 via the bottom plate 141 of the friction plate bracket portion 140.

Since the clamping bolt 121 is in a fastened state, the pair of side plates 142 and 142 are sandwiched between the pair of outer column support portions 112 and 112 and the pair of clamp portions 53 and 53, thereby providing sufficient frictional force to withstand the collision energy. Therefore, the forward movement of the restriction plate 151 due to the collision energy is reliably restricted. In this way, in the event of a secondary collision, the restriction plate 151 does not move due to the frictional force between the pair of clamp portions 53 and 53, the pair of outer column support portions 112 and 112, and the pair of side plates 142 and 142, so that the telescopic position can be maintained.

When a collision force (collision energy) exceeding the frictional force between the inner pipe 30 and the restriction plate 151 is generated, the inner pipe 30 and the coupling bolt 154 move in the forward movement direction Ad (toward the vehicle front Fr) relative to the outer column 40 and the restriction plate 151 while absorbing the collision energy through the frictional force. The collision energy is absorbed by the frictional force between the inner pipe 30 and the restriction plate 151 and the frictional force between the inner pipe 30 and the outer column 40 generated by the fastening force of the coupling bolt 154. The inner pipe 30 and the coupling bolt 154 move along the elongated hole 153 in the forward movement direction Ad (toward the vehicle front Fr) relative to the outer column 40 and the restriction plate 151.

The above description can be summarized as follows.

Referring to FIG. 3 and FIG. 4, the steering apparatus 10 includes the inner pipe 30 that accommodates and rotatably supports the steering shaft 20; and the outer column 40 including the pair of clamp portions 53 and 53 that hold the inner pipe 30 so as to be movable and fixable in the vehicle front-rear direction R1.

The outer column 40 includes the holding cylinder 50 that holds the inner pipe 30, the upper extension portion 70 extending from the upper portion of the holding cylinder 50 toward the front Fr of the vehicle body, the lower extension portion extending from the lower portion of the holding cylinder 50 toward the front Fr of the vehicle body, and the support portion 60 formed integrally with the front end of the upper extension portion 70 and the front end of the lower extension portion 80 and supporting the steering shaft 20.

The support portion 60 is coupled to the vehicle body support bracket 100 via the pivots 90 and 90 so as to be swingable up and down. The space between the upper extension portion 70 and the lower extension portion 80 penetrates entirety from the holding cylinder 50 to the support portion 60 in the vehicle width direction R2.

In this way, by appropriately setting the separation distance Sd (see FIG. 7A) between the upper extension portion 70 and the lower extension portion 80 and the cross-sectional shape or size of each of the extension portions 70 and 80, the rigidity of the outer column 40 can be set to an optimum level. Moreover, the space between the upper extension portion 70 and the lower extension portion 80 penetrates entirety from the holding cylinder 50 to the support portion 60 in the vehicle width direction R2 (left-right direction R2), and is the cavity 40a. For this reason, the size or weight of the outer column 40 can be reduced. Therefore, the size or weight of the steering apparatus 10 can be reduced while increasing the rigidity of the outer column 40, and the layout flexibility of the steering apparatus 10 with respect to the vehicle body Cb can be improved.

Referring to FIG. 8A and FIG. 8B, the vehicle body support bracket 100 includes the bracket portion 101 extending from the pivots 90 and 90 toward the holding cylinder 50 while covering the upper side of the upper extension portion 70. The bracket portion 101 has the pair of insertion grooves 105 and 105 through which the fastening members 104 for fastening to the vehicle body Cb can be inserted in the vehicle body up-down direction R3. The pair of insertion grooves 105 and 105 are located on both sides in the direction along the center line CL2 of the pivots 90 and 90 (left-right direction R2) with respect to the axis CL1 of the holding cylinder 50. The width W1 of the upper extension portion 70 and the width W2 of the lower extension portion 80 are smaller than the spacing Ds between the pair of insertion grooves 105 and 105.

As illustrated in FIG. 1, when the steering apparatus 10 is mounted to the vehicle body Cb, the fastening members 104 and 104 such as bolts are inserted into the pair of insertion grooves 105 and 105, and are fastened by the tool Tu. Since the width W1 of the upper extension portion 70 and the width W2 of the lower extension portion 80 are smaller than the spacing Ds between the pair of insertion grooves 105 and 105, a space corresponding to the difference can be used as a working space for handling the tool Tu. Therefore, workability (assemblability) of mounting the steering apparatus 10 to the vehicle body Cb can be enhanced. Moreover, by reducing the width W1 of the upper extension portion 70 and the width W2 of the lower extension portion 80, the layout flexibility of the steering apparatus 10 with respect to the vehicle body Cb can be further enhanced.

Referring to FIG. 1 and FIG. 7A, the upper extension portion 70 and the lower extension portion 80 are parallel to the axis CL1 of the holding cylinder 50. The pivots 90 and 90 are located on the extension line EL of the upper extension portion 70.

The outer column 40 is supported by the vehicle body Cb via the pivots 90 and 90 so as to be swingable up and down. When a large load in a push-down direction is applied to the steering wheel 11 in state where the inner pipe 30 is fastened to the outer column 40, a large bending load acts on the upper extension portion 70. Since the pivots 90 and 90 are located on the extension line EL of the upper extension portion 70, the load is more smoothly transmitted from the upper extension portion 70 to the pivots 90 and 90 compared to a case where the pivots 90 and 90 are offset. Therefore, the rigidity of the outer column 40 can be easily increased.

Referring to FIG. 4, FIG. 6, and FIG. 12A, the steering apparatus 10 further includes the restriction bracket 130 that adjusts and restricts the position of the inner pipe 30 in the vehicle front-rear direction R1 relative to the outer column 40.

The restriction bracket 130 includes the friction plate bracket portion 140 capable of generating a frictional force with the outer surfaces 53b and 53b of the pair of clamp portions 53 and 53 by fastening of the clamping bolt 121, and the restriction portion 150 located between the pair of clamp portions 53 and 53 to overlap the outer peripheral surface 32 of the inner pipe 30 and extending along the longitudinal direction R1 (vehicle front-rear direction R1) of the inner pipe 30.

The restriction portion 150 has the elongated hole 153 along the longitudinal direction R1 of the inner pipe 30, and is coupled while restricting the relative displacement of the inner pipe 30 in the longitudinal direction R1 by friction against the outer peripheral surface 32 of the inner pipe 30 generated by the fastening force of the coupling bolt 154 passing through the elongated hole 153.

The lower extension portion 80 has the elongated hole 84 (slit 84) extending continuously from the opening 51 between the pair of clamp portions 53 and 53 toward the support portion 60.

At least a part of the restriction portion 150 is inserted into the elongated hole 84.

In this way, the restriction portion 150 of the restriction bracket 130 is located between the pair of clamp portions 53 and 53 to overlap the outer peripheral surface 32 of the inner pipe 30 while extending along the longitudinal direction R1 of the inner pipe 30. At least a part of the restriction portion 150 is inserted into the elongated hole 84 of the lower extension portion 80. That is, at least a part of the restriction portion 150 overlaps the lower extension portion 80 in a radial direction of the holding cylinder 50. The size of the outer column 40 to which the restriction bracket 130 is assembled can be reduced by that amount. As a result, the size of the steering apparatus 10 can be further reduced.

Referring to FIG. 4, FIG. 10, and FIG. 14, the steering apparatus 10 further includes the restriction bracket 130 that adjusts and restricts the position of the inner pipe 30 in the vehicle front-rear direction R1 relative to the outer column 40.

The restriction bracket 130 includes the friction plate bracket portion 140 that is a U-shaped member formed from a sheet material and that is capable of generating a frictional force with the outer surfaces 53b and 53b of the pair of clamp portions 53 and 53 by fastening of the clamping bolt 121, and the restriction portion 150 that is an inverted U-shaped member formed from a sheet material, the restriction portion 150 being located between the pair of clamp portions 53 and 53 to overlap the outer peripheral surface 32 of the inner pipe 30 and extending along the longitudinal direction R1 (front-rear direction R1) of the inner pipe 30.

The restriction portion 150 has the elongated hole 153 along the longitudinal direction R1 of the inner pipe 30, and is coupled while restricting the relative displacement of the inner pipe 30 in the longitudinal direction R1 by friction against the outer peripheral surface 32 of the inner pipe 30 generated by the fastening force of the coupling bolt 154 passing through the elongated hole 153.

The restriction portion 150 is formed as a member separate from the friction plate bracket portion 140. The restriction portion 150 is assembled to the friction plate bracket portion 140.

Since the friction plate bracket portion 140 is a member that generates a frictional force with the outer surfaces 53b and 53b of the pair of clamp portions 53 and 53, the friction plate bracket portion 140 does not need to have particularly high rigidity. On the other hand, since the restriction portion 150 needs to sufficiently and promptly absorb collision energy in the event of a secondary collision by the fastening force of the coupling bolt 154, the restriction portion 150 is required to have high rigidity. In contrast, the friction plate bracket portion 140 and the restriction portion 150 having different rigidities are formed as separate members, and are assembled with each other. Therefore, the rigidity of each of the friction plate bracket portion 140 and the restriction portion 150 can be more appropriately and easily set. Moreover, the friction plate bracket portion 140 and the restriction portion 150 can be more easily produced compared to a case where the friction plate bracket portion 140 and the restriction portion 150 are formed from a single sheet material.

The invention is not limited to the embodiment as long as the functions and effects of the invention are achieved, and can be applied to various steering apparatuses.

The steering apparatus 10 of the invention is suitable for being employed in a steering system of a passenger vehicle.

What is claimed is:

1. A steering apparatus comprising:
an inner pipe that accommodates and rotatably supports a steering shaft; and
an outer column including a pair of clamp portions that hold the inner pipe so as to be movable and fixable in a vehicle front-rear direction,
wherein the outer column includes a holding cylinder that holds the inner pipe, an upper extension portion extending from an upper portion of the holding cylinder toward a front of a vehicle body, a lower extension portion extending from a lower portion of the holding cylinder toward the front of the vehicle body, and a support portion formed integrally with a front end of the upper extension portion and a front end of the lower extension portion and supporting the steering shaft,
the support portion is coupled to a vehicle body support bracket via pivots so as to be swingable up and down, and
a space between the upper extension portion and the lower extension portion penetrates entirely from the holding cylinder to the support portion in a vehicle width direction.

2. The steering apparatus according to claim 1,
wherein the vehicle body support bracket includes a bracket portion extending from the pivots toward the holding cylinder while covering an upper side of the upper extension portion,
the bracket portion has a pair of insertion grooves through which fastening members for fastening to the vehicle body can be inserted in a vehicle body up-down direction,
the pair of insertion grooves are located on both sides in a direction along a center line of the pivots with respect to an axis of the holding cylinder, and
a width of the upper extension portion and a width of the lower extension portion are smaller than a spacing between the pair of insertion grooves.

3. The steering apparatus according to claim 1,
wherein the upper extension portion and the lower extension portion are parallel to an axis of the holding cylinder, and
the pivots are located on an extension line of the upper extension portion.

4. The steering apparatus according to claim 1, further comprising:
a restriction bracket that adjusts and restricts a position of the inner pipe in the vehicle front-rear direction relative to the outer column,
wherein the restriction bracket includes a friction plate bracket portion capable of generating a frictional force with outer surfaces of the pair of clamp portions by fastening of a clamping bolt, and a restriction portion located between the pair of clamp portions to overlap an outer peripheral surface of the inner pipe and extending along a longitudinal direction of the inner pipe,
the restriction portion has an elongated hole along the longitudinal direction of the inner pipe, and is coupled while restricting a relative displacement of the inner pipe in the longitudinal direction by friction against the outer peripheral surface of the inner pipe generated by a fastening force of a coupling bolt passing through the elongated hole,
the lower extension portion has an elongated hole extending continuously from an opening between the pair of clamp portions toward the support portion, and
at least a part of the restriction portion is inserted into the elongated hole.

5. The steering apparatus according to claim 1, further comprising:
a restriction bracket that adjusts and restricts a position of the inner pipe in the vehicle front-rear direction relative to the outer column,
wherein the restriction bracket includes a friction plate bracket portion that is a U-shaped member formed from a sheet material and that is capable of generating a frictional force with outer surfaces of the pair of clamp portions by fastening of a clamping bolt, and a restriction portion that is an inverted U-shaped member formed from a sheet material, the restriction portion being located between the pair of clamp portions to overlap an outer peripheral surface of the inner pipe and extending along a longitudinal direction of the inner pipe,
the restriction portion has an elongated hole along the longitudinal direction of the inner pipe, and is coupled while restricting a relative displacement of the inner pipe in the longitudinal direction by friction against the outer peripheral surface of the inner pipe generated by a fastening force of a coupling bolt passing through the elongated hole,
the restriction portion is formed as a member separate from the friction plate bracket portion, and
the restriction portion is assembled to the friction plate bracket portion.
